(19) United States
(12) Patent Application Publication
(10) Pub. No.: US 2025/0297429 A1
(43) Pub. Date: Sep. 25, 2025

(54) COATED, RECYCLED PAPER STOCK PRODUCT AND RELATED MANUFACTURING TECHNIQUES

(71) Applicant: Monadnock Paper Mills, Inc., Bennington, NH (US)

(72) Inventors: Fuushern Wuu, Rindge, NH (US); Rajan Iyer, Lawrenceville, GA (US)

(21) Appl. No.: 19/086,503

(22) Filed: Mar. 21, 2025

Related U.S. Application Data
(60) Provisional application No. 63/569,291, filed on Mar. 25, 2024.

(51) Int. Cl. D21H 27/32; B32B 29/00; D21H 11/14; D21H 19/20

(52) U.S. Cl. CPC D21H 27/32; B32B 29/005; D21H 11/14; D21H 19/20; B32B 2255/12; B32B 2255/26; B32B 2425/00

(57) ABSTRACT

A coated, recycled paper stock product and related manufacturing techniques are disclosed. In accordance with some embodiments, the disclosed product may include a plurality of constituent paper layers which have been adhered together by a corresponding quantity of interstitial adhesive layers. Any one (or all) of such constituent paper layers may be made from 100% (wt %) recycled fiber, in accordance with some embodiments. Optionally, the disclosed product further may include one or more coating layers on a given constituent paper layer. In accordance with some embodiments, either (or both) of the outermost paper layers may include a coating layer disposed over the external surface (e.g., printable side) thereof. In this manner, a laminated paper product may be provided having coating(s) (or otherwise being treated with one or more treatments of a physical and/or chemical nature) for printing on multiple printing platforms, in accordance with some embodiments.

### CROSS-REFERENCE TO RELATED APPLICATIONS

This patent application claims the benefit of U.S. Provisional Patent Application No. 63/569,291, titled “Coated, Recycled Paper Stock Product and Related Manufacturing Techniques,” filed on Mar. 25, 2024, which is herein incorporated by reference in its entirety.

### FIELD OF THE DISCLOSURE

The present disclosure relates to paper stock products and, more particularly, to coated paper stock products.

### BACKGROUND

Coated paper is paper which has been coated by a mixture of materials or a polymer to impart certain qualities to the paper. A wide range of paper products, including technical and specialty paper materials, as well as premium printing and packaging papers, can be made using coated paper.

### SUMMARY

The subject matter of this application may involve, in some cases, interrelated products, alternative solutions to a particular problem, and/or a plurality of different uses of a single system or article.

A first example embodiment provides a paper stock product including at least two paper layers. The paper stock product further includes one or more adhesive layers disposed between the at least two paper layers. The paper stock product further includes at least one coating layer disposed over at least one of the at least two paper layers and including: a first coating material; and a second coating material of differing material composition from the first coating material.

In some cases, at least one of the at least two paper layers includes a recycled material. In some instances, the recycled material includes a post-consumer recycled material. In some instances, the recycled material includes a post-industrial recycled material. In some instances, the recycled material includes both post-consumer recycled material and post-industrial recycled material. In some cases, the at least two paper layers include substantially 100% recycled material.

In some cases, the at least two paper layers include only four paper layers. In some cases, the at least two paper layers include only six paper layers.

In some cases, at least one of the one or more adhesive layers includes a glue. In some cases, at least one of the one or more adhesive layers includes a compostable adhesive.

In some cases, at least one of the first coating material and the second coating material includes ethylene-acrylic acid. In some cases, at least one of the first coating material and the second coating material includes ethylene-methacrylic acid in a polyurethane emulsion or rosin. In some cases: the first coating material includes ethylene-acrylic acid; and the second coating material includes ethylene-methacrylic acid in a polyurethane emulsion or rosin. In some cases, at least one of the first coating material and the second coating material includes a latex-based material. In some cases, at least one of the first coating material and the second coating material comprises latex and vinylformamide (VFA). In some cases, the at least one coating layer emits substantially no 4-vinylcylcohexene (4-VCH).

In some cases, the at least one coating layer is disposed over at least one surface of an outermost one of the at least two paper layers. In some instances, the at least one surface is a printable exterior surface.

In some cases: the at least one coating layer includes a first coating layer and a second coating layer; the first coating layer is disposed over at least one surface of a first outermost one of the at least two paper layers; and the second coating layer is disposed over at least one surface of a second outermost one of the at least two paper layers. In some instances: the at least one surface of the first outermost one of the at least two paper layers is a first printable exterior surface thereof; and the at least one surface of the second outermost one of the at least two paper layers is a second printable exterior surface thereof.

A second example embodiment provides a paper product including the paper stock product of the first example embodiment. In some instances, the paper product is a gift card. In some instances, the gift card is machine-readable. In some instances, the paper product further includes a magnetic strip element disposed over an exterior surface of the gift card.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a cross-sectional view of a portion of a paper stock product configured in accordance with an embodiment of the present disclosure.

FIG. 2 illustrates a cross-sectional view of a portion of a paper layer with one or more optional coating layers configured in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A coated, recycled paper stock product and related manufacturing techniques are disclosed. In accordance with some embodiments, the disclosed product may include a plurality of constituent paper layers which have been adhered together by a corresponding quantity of interstitial adhesive layers. Any one (or all) of such constituent paper layers may be made from 100% (wt %) recycled fiber, in accordance with some embodiments. Optionally, the disclosed product further may include one or more coating layers on a given constituent paper layer. In accordance with some embodiments, either (or both) of the outermost paper layers may include a coating layer disposed over the external surface (e.g., printable side) thereof. In this manner, a laminated paper product may be provided having coating(s) (or otherwise being treated with one or more treatments of a physical and/or chemical nature) for printing on multiple printing platforms, in accordance with some embodiments. Numerous configurations and variations will be apparent in light of this disclosure.

### General Overview

As is known, paper stock products can be formed utilizing recycled paper fibers. However, the recycled fibers typically lose strength when reused. Thus, in making such products, recycled fibers normally are mixed with virgin fibers to make new material. Typically, to ensure sufficient strength for end-use, such paper stock products utilize only 20-30% (wt %) recycled fibers.

Thus, and in accordance with some embodiments of the present disclosure, a coated, recycled paper stock product and related manufacturing techniques are disclosed. In accordance with some embodiments, the disclosed product may include a plurality of constituent paper layers which have been adhered together by a corresponding quantity of interstitial adhesive layers. Any one (or all) of such constituent paper layers may be made from 100% (wt %) recycled fiber, in accordance with some embodiments. Optionally, the disclosed product further may include one or more coating layers on a given constituent paper layer. In accordance with some embodiments, either (or both) of the outermost paper layers may include a coating layer disposed over the external surface (e.g., printable side) thereof. In this manner, a laminated paper product may be provided having coating(s) (or otherwise being treated with one or more treatments of a physical and/or chemical nature) for printing on multiple printing platforms, in accordance with some embodiments.

In accordance with some embodiments, a paper stock product produced as disclosed herein may be utilized, for example, in producing paper gift cards. Optionally, such paper gift cards may be made machine-readable, such as through addition of a magnetic stripe capable of storing data in a constituent magnetic material and readable by an appropriate electronic device (e.g., a magnetic reading head), in accordance with some embodiments. In accordance with some embodiments, a paper stock product produced as disclosed herein may be utilized, for example, in making loyalty cards, key cards, paper tubes, advertising poster board, playing cards, and blockout poster, to name a few. In accordance with some embodiments, a paper stock product produced as disclosed herein may be suitable for use as a replacement or substitute for any of a wide range of plastic products, including, for example, plastic cards, plastic tags, and plastic poster boards, among others. Numerous suitable uses and applications will be apparent in light of this disclosure.

As will be appreciated in light of this disclosure, a paper stock product produced as disclosed herein may exhibit any of a wide range of advantages and benefits over existing approaches. For instance, in accordance with some embodiments, a paper stock product produced as disclosed herein may be 100% recyclable and re-pulpable. In accordance with some embodiments, a paper stock product produced as disclosed herein may exhibit plastic-like performance, at least in terms of its feel, flexibility, and/or weight to an end-user. In accordance with some embodiments, a paper stock product produced as disclosed herein may provide for multi-platform printability while demonstrating higher print fidelity than existing approaches. By virtue of the material composition of its coating layer(s), a paper stock product provided as described herein may be compatible, in accordance with some embodiments, for use with multiple commercial printing technologies, including, for example, thermal offset printing and offset lithography printing, among others. Moreover, by virtue of said material composition, a paper stock product provided as described herein may exhibit no (or otherwise minimal) emission of volatile organic compounds (VOCs), such as 4-vinylcyclohexene (4-VCH), in accordance with some embodiments. Other advantages and benefits relating to a paper stock product produced as variously disclosed herein will depend on a given target application or end-use and will be apparent in light of this disclosure.

### Paper Stock Product Structure

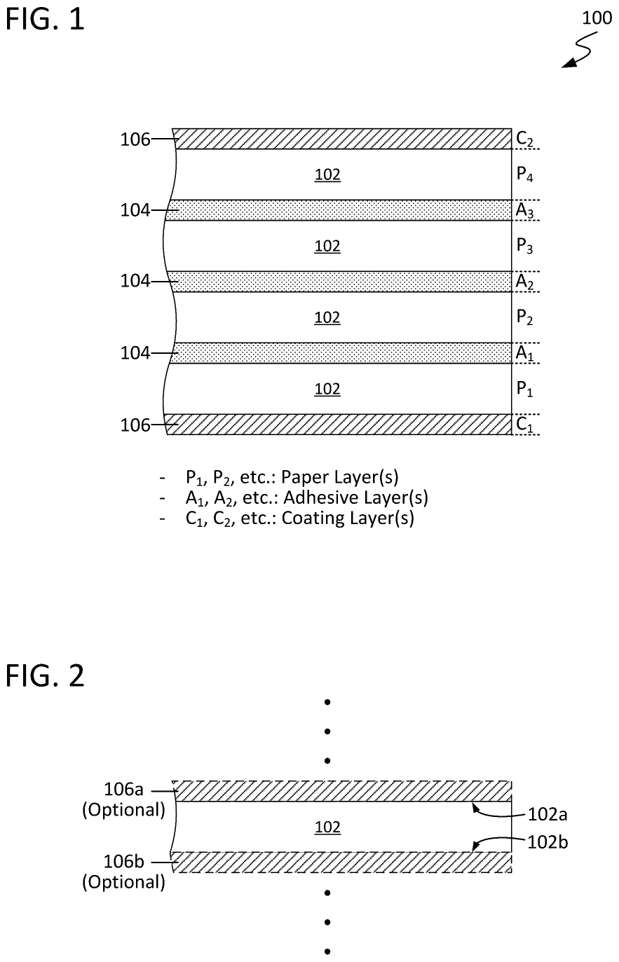

FIG. 1 illustrates a cross-sectional view of a portion of a paper stock product 100 configured in accordance with an embodiment of the present disclosure. As can be seen, product 100 may include a plurality (e.g., two or more) of paper layers 102. Product 100 also may include one or more adhesive layers 104, with neighboring paper layers 102 being adhered together via an intervening adhesive layer 104. Furthermore, product 100 may include one or more coating layers 106, which may be disposed over one or more sides of a given paper layer 102. In the example illustrated via FIG. 1, each of the outermost paper layers 102 has an associated coating layer 106 disposed thereover, though it should be noted that the present disclosure is not intended to be so limited. Each of these elements of product 100 is discussed in turn below.

As noted above, product 100 may include a plurality of constituent paper layers 102, the quantity of which may be customized, as desired for a given target application or end-use. That is, product 100 may include two or more (e.g., two, three, four, five, six, or more) paper layers 102. In some cases, such as that seen in FIG. 1, product 100 may include a total of four paper layers 102. In some other cases, product 100 may include, for example, a total of six paper layers 102. More generally, product 100, as a multi-ply, paper-based body, may have at least two paper layers 102. Additionally, as can be seen from FIG. 1, the constituent paper layers 102 of product 100 may be positioned in a generally stacked or sandwiched arrangement along with adhesive layer(s) 104 (discussed below).

In accordance with some embodiments, a given paper layer 102 may be made, in part or in whole, from recycled fibers, which may be classified as post-consumer waste and/or post-industrial waste. The amount of recycled fiber utilized in a given paper layer 102 may be customized, as desired for a given target application or end-use. For example, in some cases, a given paper layer 102 may have a recycled fiber content of at least about 50% (wt %) (e.g., at least 50%, at least 60%, at least 70%, at least 80%, at least 90%, or any other sub-range in the range of at least 50%). In some instances, a given paper layer 102 may have a recycled fiber content of about 95% (wt %)+5% (wt %). In some instances, a given paper layer 102 may have a recycled fiber content of substantially 100% (wt %) (e.g., exactly 100% or within 2% less than 100%). In some cases, one or more plies of product 100 may be made with 100% post-consumer waste pulp. In accordance with some embodiments, each constituent paper layer 102 of product 100 may have a recycled fiber content of substantially 100% (wt %).

In some cases, a given paper layer 102 may be formed using a single type of recycled fiber, whereas in other cases, two or more different types of recycled fibers may be utilized. As will be appreciated in light of this disclosure, it may be desirable, at least in some cases, to form a given paper layer 102 utilizing type(s) of pulp fibers selected to achieve a target brightness range for that paper layer 102 (or finished product 100 more generally). In some cases, a given paper layer 102 may be of a size press formulation containing, for example, latex to impart density and achieve a target range of stiffness for that paper layer 102 (or finished product 100 more generally).

Furthermore, the thickness (e.g., caliper) of a given paper layer 102 may be customized, as desired for a given target application or end-use. For example, in some cases, a given paper layer 102 may have an average thickness in the range of about 6.5-8.5 pt (1 pt 25.4 μm) (e.g., about 6.5-7.0 pt, about 7.0-7.5 pt, about 7.5-8.0 pt, about 8.0-8.5 pt, or any other sub-range in the range of about 6.5-8.5 pt). In some cases, a given paper layer 102 may have an average thickness in the range of about 3-18 mils (e.g., about 3-8 mils, about 8-13 mils, about 13-18 mils, or any other sub-range in the range of about 3-18 mils). In some cases, a given paper layer 102 may have a minimum thickness of about 5 pt and a maximum thickness of about 16 pt. In some cases, a given paper layer 102 may have a minimum thickness of about 2-3 mils and a maximum thickness of about 17-18 mils. In some cases, a given paper layer 102 may be formed with substantially uniform thickness, whereas in other cases, a non-uniform thickness may be provided. In some instances, all constituent paper layers 102 of product 100 may be of substantially the same thickness (e.g., within +5% of one another), though in other instances, one or more paper layers 102 may differ in thickness from one or more other paper layers 102.

Also, as noted above, product 100 may include one or more constituent adhesive layers 104, the quantity of which may be customized, as desired for a given target application or end-use, and may depend, at least in part, on the quantity of constituent paper layers 102 present in product 100. That is, if product 100 includes only two constituent paper layers 102, for example, then a single adhesive layer 104 may be disposed therebetween. In cases in which product 100 includes three or more constituent paper layers 102, for example, a single adhesive layer 104 may be disposed between a given pair of such paper layers 102 (e.g., between any two neighboring paper layers 102). For instance, as can be seen from FIG. 1, product 100 may include three constituent adhesive layers 104 disposed between four constituent paper layers 102. More generally, product 100, as a multi-ply, paper-based body, may have at least one adhesive layer 104. In accordance with some embodiments, where the quantity of paper layers 102 in product 100 is expressed as variable (n), the quantity of adhesive layers 104 in that product 100 may be expressed by the relationship (n−1). Additionally, as can be seen from FIG. 1, the constituent adhesive layers 104 of product 100 may be positioned in a generally stacked or sandwiched arrangement along with paper layers 102.

The material composition of a given adhesive layer 104 may be customized, as desired for a given target application or end-use. Generally, a given adhesive layer 104 may be made, in part or in whole, from any of a wide range of natural or synthetic adhesive materials suitable to adhere (e.g., glue or otherwise hold together) neighboring paper layers 102, in accordance with some embodiments. For example, in some cases, a given adhesive layer 104 may be made, in part or in whole, from any one (or combination) of vinyl acetate ethylene copolymer, polyvinyl acetate, dextrin, and starch, to name a few. In some cases, a given adhesive layer 104 optionally may be compostable. In some cases, a given adhesive layer 104 may be formed using a single type of adhesive material, whereas in other cases, two or more different types of adhesive materials may be utilized.

Furthermore, the amount of a given adhesive layer 104 utilized in producing product 100 may be customized, as desired for a given target application or end-use. For example, in some cases, the average amount of a given adhesive layer 104 as applied to a given paper layer 102 may be in the range of about 10-12 g/m² (gsm) (e.g., about 10.0-10.5 g/m², about 10.5-11.0 g/m², about 11.0-11.5 g/m², about 11.5-12.0 g/m², or any other sub-range in the range of about 10-12 g/m²). In some cases, the minimum amount of a given adhesive layer 104 utilized may be in the range of about 3-5 g/m² (gsm) (e.g., about 3.0-3.5 g/m², about 3.5-4.0 g/m², about 4.0-4.5 g/m², about 4.5-5.0 g/m², or any other sub-range in the range of about 3-5 g/m²). In some cases, the maximum amount of a given adhesive layer 104 may be in the range of about 30-35 g/m² (gsm) (e.g., about 30.0-32.5 g/m², about 32.5-35.0 g/m², or any other sub-range in the range of about 30-35 g/m²). In some cases, a given adhesive layer 104 may be formed with substantially uniform coat weight distribution, whereas in other cases, a non-uniform coat weight distribution may be provided. In some instances, all constituent adhesive layers 104 of product 100 may be of substantially the same coat weight distribution (e.g., within +5% of one another), though in other instances, one or more adhesive layers 104 may differ in coat weight distribution from one or more other adhesive layers 104.

Furthermore, as noted above, product 100 may include one or more coating layers 106, the quantity of which may be customized, as desired for a given target application or end-use, and may depend, at least in part, on the quantity of constituent paper layers 102 present in product 100. That is, a given constituent paper layer 102 of product 100 optionally may have one or more coating layers 106 disposed over a given surface thereof. For example, consider FIG. 2, which illustrates a cross-sectional view of a portion of a paper layer 102 with one or more optional coating layers 106 configured in accordance with an embodiment of the present disclosure. As generally shown in FIG. 2, a given paper layer 102 optionally may include (1) a first coating layer 106a disposed over a first surface 102a thereof and/or (2) a second coating layer 106b disposed over a second surface 102b thereof. In some cases, coating layers 106a, 106b may be of the same material composition, though in other cases, they may differ in material composition.

In accordance with some embodiments, a given coating layer 106a, 106b may be disposed directly on (e.g., in direct physical contact with) an associated paper layer 102. In accordance with some other embodiments, a given coating layer 106a, 106b may be disposed indirectly on (e.g., with one or more physically intervening layers) an associated paper layer 102.

In accordance with some embodiments, a given coating layer 106a, 106b may be disposed over an entirety of a given surface 102a, 102b of an associated paper layer 102. In accordance with some other embodiments, a given coating layer 106a, 106b may be disposed over only a portion of a given surface 102a, 102b of an associated paper layer 102. That is, in such cases, at least one region of a given surface 102a, 102b may have a given coating layer 106a, 106b disposed thereover while at least one other region of that same surface 102a, may be devoid of that same (or any other) coating layer 106a, 106b. In accordance with some embodiments, a given coating layer 106a, 106b may be formed in a patterned manner over a given surface 102a, 102b of an associated paper layer 102, such pattern being customized as desired for a given target application or end-use.

It should be noted that, in some embodiments of product 100, a coating layer 106 might not be disposed over each and every constituent paper layer 102. For example, returning to FIG. 1, in accordance with some embodiments, only the outermost paper layer(s) 102 of product 100 may have coating layer(s) 106 disposed thereover. That is, as generally can be seen from FIG. 1, an exterior surface (e.g., a printable surface) of either (or both) of the outermost paper layers 102 may have a corresponding coating layer 106 disposed thereon, in accordance with some embodiments. More specifically, (1) a first outermost paper layer 102 (denoted as P₁ in FIG. 1) may have a first coating layer 106 (denoted as C₁ in FIG. 1) disposed thereover and/or (2) a second outermost paper layer 102 (denoted as P₄ in FIG. 1) may have a second coating layer 106 (denoted as C₂ in FIG. 1) disposed thereover. Furthermore, as noted above, such first and second coating layers 106 may or may not be of the same material composition, as desired for a given target application or end-use. Thus, a product 100 of the example configuration seen in FIG. 1 generally may be characterized as having two face plies of coating layer 106 material(s).

As described herein, a given coating layer 106 may be of a material composition which is compatible for use any of a wide range of printing technologies, commercial or otherwise. For example, in accordance with some embodiments, a given coating layer 106 may be compatible with one or more of the HP Indigo Digital Press processes of HP Inc.'s Graphic Solutions Business. More specifically, a given coating layer 106 (and, thus, product 100 more generally) may be compatible with HP Indigo 15 k to 250 k presses, in accordance with some embodiments. Additionally (or alternatively), a given coating layer 106 may be compatible with an inkjet-based printing process, such as, for example, ultraviolet (UV) inkjet printing, latex inkjet printing, eco-solvent inkjet printing, and solvent inkjet printing, among others. Additionally (or alternatively), a given coating layer 106 may be compatible with an offset printing (e.g., offset lithography) process. In this manner, a product 100 provided as variously described herein may be compatible, by design, with multiple printing platforms, in accordance with some embodiments.

To such ends, a given coating layer 106 may include one or more of a wide range of materials. For example, in accordance with some embodiments, a given coating layer 106 may include (1) ethylene-acrylic acid and/or (2) ethylene-methacrylic acid in a polyurethane emulsion or rosin. In accordance with some embodiments, a given coating layer 106 may include (1) an acrylic dispersion containing styrene and acrylonitrile, such as ACRONAL® S 504 NA latex produced by BASF Corp. and/or (2) a primer for digital printing or indigo ink adhesion promoter, such as DIGIPRIME® 191245PX (DIGIPRIME® Edge 3500) produced by Michelman, Inc. In accordance with some embodiments, a given coating layer 106 may include one or more primer coatings or other materials disclosed, for example, in U.S. Pat. No. 7,767,294, the disclosure of which is herein incorporated by reference in its entirety. In accordance with some embodiments, a given coating layer 106 may include a digital printing or indigo ink adhesion promoter comprising a homopolymer of vinylformamide (VFA), such as LOXANOL® MI 6100 produced by BASF Corp. In accordance with some embodiments, a given coating layer 106 may include a latex-based material. In accordance with some embodiments, a given coating layer 106 may include a latex and VFA. In accordance with some embodiments, a given coating layer 106 may have an inorganic mineral content in the range of about 70-90% (wt %) (e.g., about 70-80%, about 80-90%, or any other sub-range in the range of about 70-90%).

In cases where a given coating layer 106 includes, for example, a mixture of the aforementioned ACRONAL® S 504 NA and DIGIPRIME® 191245PX, the ratio of such materials may be customized, as desired for a given target application or end-use. In accordance with some embodiments, such materials may be mixed in a ratio in the range of about 1:1 to 5:1 ACRONAL® S 504 NA to DIGIPRIME® 191245PX. In accordance with some embodiments, such materials may be mixed from 0-100% by dry weight.

In cases where a given coating layer 106 includes, for example, a mixture of the aforementioned ACRONAL® S 504 NA and LOXANOL® MI 6100, the ratio of such materials may be customized, as desired for a given target application or end-use. In accordance with some embodiments, such materials may be mixed in a ratio of about 12:1 ACRONAL® S 504 NA to LOXANOL® MI 6100. In accordance with some embodiments, such materials may be mixed from 0-100% by dry weight.

In accordance with some embodiments, a given coating layer 106 optionally may include one or more binders in its material composition. When utilized, a given binder may be (or otherwise may include) one or more polymers of a natural or synthetic nature. In accordance with some embodiments, a given binder may not be (or otherwise may not include) solvent-based solutions or dispersions. In accordance with some embodiments, a given binder utilized may contain no or a minimal (or an otherwise negligible amount of) volatile organic compounds (VOCs), such as 4-vinylcyclohexene (4-VCH). An example of a suitable binder may include GENCRYL™ PT 9620 binder produced by Synthomer PLC. When included, a given coating layer 106 may have a binder content in the range of about 10-100% (wt %) (e.g., about 10-20%, about 20-30%, about 30-40%, about 40-50%, about 50-60%, about 60-70%, about 70-80%, about 80-90%, about 90-100%, or any other sub-range in the range of about 10-100%). Other suitable binder(s) for optional use in a given coating layer 106 will depend on a given target application or end-use and will be apparent in light of this disclosure.

In accordance with some embodiments, a given coating layer 106 optionally may include one or more fillers in its material composition. When utilized, a given filler may be organic, inorganic, or mineral in nature, as desired for a given target application or end-use. Some examples of suitable fillers may include calcium carbonate (ground and/or precipitated), calcined clay, kaolin clay, hydrous clay, talcum, titanium dioxide, and plastic pigment(s), to name a few. When included, a given coating layer 106 may have a filler content in the range of about 0-90% (wt %) (e.g., about 0-15%, about 15-30%, about 30-45%, about 45-60%, about 60-75%, about 75-90%, or any other sub-range in the range of about 0-90%). When utilized, a given filler may have an average particle size distribution (PSD) in the range of about 0.5-4.0 μm (e.g., about 0.5-1.0 μm, about 1.0-1.5 μm, about 1.5-2.0 μm, about 2.0-2.5 μm, about 2.5-3.0 μm, about 3.0-3.5 μm, about 3.5-4.0 μm, or any other sub-range in the range of about 0.5-4.0 μm). Other suitable filler(s) for optional use in a given coating layer 106 will depend on a given target application or end-use and will be apparent in light of this disclosure.

In accordance with some embodiments, a given coating layer 106 optionally may include one or more pigments in its material composition. When utilized, a given pigment may be organic, inorganic, or mineral in nature, as desired for a given target application or end-use. When included, a given coating layer 106 may have a pigment content in the range of about 0-90% (wt %) (e.g., about 0-15%, about 15-30%, about 30-45%, about 45-60%, about 60-75%, about 75-90%, or any other sub-range in the range of about 0-90%). When utilized, a given pigment may have an average particle size distribution (PSD) in the range of about 0.5-4.0 μm (e.g., about 0.5-1.0 μm, about 1.0-1.5 μm, about 1.5-2.0 μm, about 2.0-2.5 μm, about 2.5-3.0 μm, about 3.0-3.5 μm, about 3.5-4.0 μm, or any other sub-range in the range of about 0.5-4.0 μm). Other suitable pigment(s) for optional use in a given coating layer 106 will depend on a given target application or end-use and will be apparent in light of this disclosure.

Furthermore, the amount of a given coating layer 106 utilized in producing product 100 may be customized, as desired for a given target application or end-use. For example, in some cases, the average amount of a given coating layer 106 as applied to a given paper layer 102 may be in the range of about 24-30 g/m² (gsm) (e.g., about 24.0-26.0 g/m², about 26.0-28.0 g/m², about 28.0-30.0 g/m², or any other sub-range in the range of about 24-30 g/m²). In some cases, the minimum amount of a given coating layer 106 utilized may be in the range of about 1-5 g/m² (gsm) (e.g., about 1.0-2.0 g/m², about 2.0-3.0 g/m², about 3.0-4.0 g/m², about 4.0-5.0 g/m², or any other sub-range in the range of about 1-5 g/m²). In some cases, the maximum amount of a given coating layer 106 utilized may be in the range of about 51-57 g/m² (gsm) (e.g., about 51.0-53.0 g/m², about 53.0-55.0 g/m², about 55.0-57.0 g/m², or any other sub-range in the range of about 51-57 g/m²). In some cases, a given coating layer 106 may be formed with substantially uniform coat weight distribution, whereas in other cases, a non-uniform coat weight distribution may be provided. In some instances, all constituent coating layers 106 of product 100 may be of substantially the same coat weight distribution (e.g., within ±5% of one another), though in other instances, one or more coating layers 106 may differ in coat weight distribution from one or more other coating layers 106.

In applying a given coating layer 106 in forming product 100, said coating layer 106 may be applied to an associated paper layer 102 utilizing any of a wide range of techniques. For example, in accordance with some embodiments, a given coating layer 106 may be applied, in part or in whole, utilizing any one (or combination) of a size press, a rod coater, a blade coater, a curtain coater, a gravure coater, a flexo coater, and an offset coater, among others.

In addition, the overall thickness (e.g., caliper) of product 100 may be customized, as desired for a given target application or end-use and may depend, at least in part, on the quantity and dimensions of its constituent layers 102, 104, 106. For example, in some cases, product 100 may have an average thickness in the range of about 24-34 mils (e.g., about 24-26 mils, about 26-28 mils, about 28-30 mils, about 30-32 mils, 32-34 mils, or any other sub-range in the range of about 24-34 mils). In some cases, product 100 may have a minimum thickness of about 20 mils and a maximum thickness of about 34 mils. In some cases, product 100 may have a minimum thickness in the range of about 22-26 mils. In some cases, product 100 may have a maximum thickness in the range of about 32-34 mils. In some cases, product 100 may be formed with substantially uniform thickness, whereas in other cases, a non-uniform thickness may be provided. In an example case, product 100 may be formed as a 30-pt paper having a thickness of about 0.030 inches (±0.005 inches).

Furthermore, as will be appreciated in light of this disclosure, the overall physical and optical characteristics of product 100 may be customized, as desired for a given target application or end-use and may depend, at least in part, on the characteristics of its constituent layers 102, 104, 106. For example, in accordance with some embodiments, a product 100 produced as described herein may have a brightness (ISO) in the range of about 80-90% (e.g., about 80-82.5%, about 82.5-85%, about 85-87.5%, about 87.5-90%, or any other sub-range in the range of about 80-90%). In accordance with some embodiments, a product 100 produced as described herein may have a given CIELAB color space value in any one or more of the ranges indicated in Table 1 below:

TABLE 1

| CIELAB Color | |
|---|---|
| Space Value: | Range: |
| L* | About 90 or greater (e.g., about 90 or greater, about 92 or |
| | greater, about 94 or greater, about 96 or greater, about 98 |
| | or greater, or any other sub-range in the range of about 90 |
| | or greater) |
| a* | About 0.0 to −2.0 (e.g., about 0.0 to −0.5, about −0.5 to −1.0, |
| | about −1.0 to −1.5, about −1.5 to −2.0, or any other sub-range |
| | in the range of about 0.0 to −2.0) |
| b* | About 0.0 to −3.0 (e.g., about 0.0 to −0.5, about −0.5 to −1.0, |
| | about −1.0 to −1.5, about −1.5 to −2.0, about −2.0 to −2.5, |
| | about −2.5 to −3.0, or any other sub-range in the range of |
| | about 0.0 to −3.0) |

In accordance with some embodiments, a product 100 produced as described herein may have a stiffness in the machine direction (e.g., along the axial direction in which product 100 may be fed into a printing platform) of about 80,000 GU or greater (e.g., about 85,000 GU or greater, about 90,000 GU or greater, about 95,000 GU or greater, etc.). In accordance with some embodiments, a product 100 produced as described herein may have a stiffness in the cross direction (e.g., along the axial direction perpendicular to that in which product 100 may be fed into a printing platform) of about 40,000 GU or greater (e.g., about 45,000 GU or greater, about 50,000 GU or greater, about 55,000 GU or greater, etc.). In accordance with some embodiments, a product 100 produced as described herein may have a Sheffield smoothness value of about 25 or less (e.g., about 20 or less, about 15 or less, etc.). In accordance with some embodiments, a product 100 produced as described herein may be configured to substantially maintain its physical integrity (e.g., not delaminate at the plies) when boiled in water for a period of at least about 60 minutes (e.g., about 60 minutes or more, about 65 minutes or more, about 70 minutes or more, etc.).

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

What is claimed is:

1. A paper stock product comprising:
at least two paper layers;
one or more adhesive layers disposed between the at least two paper layers; and
at least one coating layer disposed over at least one of the at least two paper layers and comprising:
a first coating material; and
a second coating material of differing material composition from the first coating material.

2. The paper stock product of claim 1, wherein at least one of the at least two paper layers comprises a recycled material.

3. The paper stock product of claim 2, wherein the recycled material comprises a post-consumer recycled material.

4. The paper stock product of claim 2, wherein the recycled material comprises a post-industrial recycled material.

5. The paper stock product of claim 2, wherein the recycled material comprises both post-consumer recycled material and post-industrial recycled material.

6. The paper stock product of claim 1, wherein the at least two paper layers comprise substantially 100% recycled material.

7. The paper stock product of claim 1, wherein the at least two paper layers include only four paper layers.

8. The paper stock product of claim 1, wherein the at least two paper layers include only six paper layers.

9. The paper stock product of claim 1, wherein at least one of the one or more adhesive layers comprises a glue.

10. The paper stock product of claim 1, wherein at least one of the one or more adhesive layers comprises a compostable adhesive.

11. The paper stock product of claim 1, wherein at least one of the first coating material and the second coating material comprises ethylene-acrylic acid.

12. The paper stock product of claim 1, wherein at least one of the first coating material and the second coating material comprises ethylene-methacrylic acid in a polyurethane emulsion or rosin.

13. The paper stock product of claim 1, wherein:
the first coating material comprises ethylene-acrylic acid; and
the second coating material comprises ethylene-methacrylic acid in a polyurethane emulsion or rosin.

14. The paper stock product of claim 1, wherein at least one of the first coating material and the second coating material comprises a latex-based material.

15. The paper stock product of claim 1, wherein at least one of the first coating material and the second coating material comprises latex and vinylformamide (VFA).

16. The paper stock product of claim 1, wherein the at least one coating layer emits substantially no 4-vinylcylcohexene (4-VCH).

17. The paper stock product of claim 1, wherein the at least one coating layer is disposed over at least one surface of an outermost one of the at least two paper layers.

18. The paper stock product of claim 17, wherein the at least one surface is a printable exterior surface.

19. The paper stock product of claim 1, wherein:
the at least one coating layer comprises a first coating layer and a second coating layer;
the first coating layer is disposed over at least one surface of a first outermost one of the at least two paper layers; and
the second coating layer is disposed over at least one surface of a second outermost one of the at least two paper layers.

20. The paper stock product of claim 19, wherein:
the at least one surface of the first outermost one of the at least two paper layers is a first printable exterior surface thereof; and
the at least one surface of the second outermost one of the at least two paper layers is a second printable exterior surface thereof.

21. A paper product comprising the paper stock product of claim 1.

22. The paper product of claim 21, wherein the paper product is a gift card.

23. The paper product of claim 22, wherein the gift card is machine-readable.

24. The paper product of claim 22, further comprising a magnetic strip element disposed over an exterior surface of the gift card.
